(19) United States
(12) Patent Application Publication
(10) Pub. No.: US 2008/0240896 A1
(43) Pub. Date: Oct. 2, 2008

(54) CASSETTE EXCHANGE SYSTEM

(75) Inventors: Wen-Ming Lo, Hsinchu County (TW); Chin-Jung Yang, Hsinchu City (TW); Gau-Maw Tseng, Hsinchu County (TW); Hsuan-Hsuan Wu, Hsinchu City (TW); Yin-Tsai Hsieh, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: POWERCHIP SEMICONDUCTOR CORP., Hsinchu (TW)

(21) Appl. No.: 12/128,631

(22) Filed: May 29, 2008

Related U.S. Application Data
(62) Division of application No. 11/162,857, filed on Sep. 26, 2005.

(30) Foreign Application Priority Data
Mar. 10, 2005 (TW) 94107258

(51) Int. Cl. B65G 65/02

(52) U.S. Cl. 414/416.03

(57) ABSTRACT

A cassette exchange system is provided. The cassette exchange system includes a wafer temporary storage apparatus, a first cassette base, a second cassette base and a moving apparatus. The wafer temporary storage apparatus includes a number of wafer carrier units. The first cassette base is suitable for carrying a first cassette, and the second cassette base is suitable for carrying a second cassette. The moving apparatus connects the first cassette base with the second cassette base. Also, the moving apparatus sequentially moves the first cassette base and the second cassette base to the wafer temporary storage apparatus to simultaneously transfer the wafers stored in the first cassette to the second cassette.

### CROSS-REFERENCE TO RELATED APPLICATION

This application is a divisional of an application Ser. No. 11/162,857, filed on Sep. 26, 2005, now pending, which claims the priority benefit of Taiwan application serial no. 94107258, filed on Mar. 10, 2005. The entirety of the above-mentioned patent applications is hereby incorporated by reference herein and made a part of this specification.

### BACKGROUND OF THE INVENTION

1. Field of the Invention

The present invention relates to a wafer transfer system, a wafer transfer method, a cassette exchange system and an exchange method thereof.

2. Description of the Related Art

Because of the continuous high integration density of semiconductor devices of integrated circuits, manufacturing process accuracy becomes more and more important. Once minor errors occur during processes, the whole manufacturing process may fail. As a result, wafers are damaged and scraped, and costs thus increase.

For a general semiconductor process, a semiconductor equipment is composed of several neighboring process chambers. By a wafer transfer system, wafers are transferred among different process chambers. During the wafer transfer among the process chambers, a robot blade takes wafers from a cassette and transfers the wafers to the process chambers for processing. After the process is complete, the wafers are taken out from the process chambers and transferred to the cassette for the next process step.

The motions of a robot blade are complicated which include moving up or down, rotating, retracting and so on. For example, if the robot blade is going to take the wafers from the cassette, the robot blade must move into the cassette and move upward to hold the wafer or to suck the back side of the wafer. The robot blade then moves out and takes the wafer out of the cassette. Note that during these steps, minor shift or displacement may cause the wafer transfer failed; or even the wafer may drop or slide so as to cause the wafer broken or scratched. Accordingly, in order to smoothly reach the wafers and remove them out of the cassette by the robot blade, it is important to maintain the stableness and condition of the robot blade.

Generally, a robot blade transfers a wafer by a micro electro-mechanical system to control its stability and accuracy. Due to the frequency of wafer transfers by the robot blade, transmission components may be aging, abraded or even distorted. For example, the abrasion of a transmission gear causes a great gap between gears; the position sensor is shifted; the bearing ages; or the vacuum system ages. All of them result in the shift of the robot blade and deteriorate the accuracy of removing the wafer by the robot blade. As a result, the robot blade may be in touch with the wafer or even scratch the wafer surface or backside or break the wafer. These factors will increase the manufacturing costs.

Additionally, wafers may need to be loaded in cassettes with different materials for different process requirements before transferred to different process chambers for processing. If all wafers in a cassette are going to be transferred to another cassette, the prior art method transfers the wafers from a cassette to another cassette piece by piece. This method increases the process time.

### SUMMARY OF THE INVENTION

Accordingly, the present invention is directed to a wafer transfer system and a wafer transfer method. According to the system and the method, costs resulting from scratching the wafer surface or backside during the wafer transfer can be avoided.

The present invention also is directed to a cassette exchange system and a cassette exchange method. According to the system and the method, wafer transfer efficiency is improved and costs resulting from scratching the wafer surface or backside during the wafer transfer can be avoided.

The present invention provides a wafer transfer system, which includes a movable body, at least one wafer carrier unit and at least two sensors. Wherein, the wafer carrier unit includes a first end and a second end opposed to the first end, and the first end connects with the movable body. The sensors are disposed at the second end of the wafer carrier unit.

According to the wafer transfer system of a preferred embodiment of the present invention, the sensors include optical sensors, wireless sensors or wired sensors.

The present invention provides a wafer transfer method. This method includes the following steps: (a) providing a cassette with at least one wafer, a determining unit and a wafer transfer system, the wafer transfer system at least including a wafer carrier unit, a first sensor and a second sensor; (b) moving the wafer carrier unit to the cassette; (c) performing a checking step to the cassette by using the first sensor and the second sensor to obtain a first signal and a second signal; (d) transmitting the first signal and the second signal to the determining unit, wherein when the determining unit determines that the first signal is equal to the second signal, or that the first signal and the second signal are equal to a preset signal of the determining unit, steps from the step (e) are performed; or when the determining unit determines that the first signal is not equal to the second signal, or that the first signal and the second signal are not equal to the preset signal of the determining unit, steps from the step (e) are not performed; and (e) unloading wafers in the cassette by the wafer carrier unit.

The wafer transfer system of the present invention includes the first sensor and the second sensor. Before the wafer is transferred, checking results from the sensors are apt to determining whether to unload the wafer in the cassette. Accordingly, the chance of scratching the wafer surface or backside during the wafer transfer is effectively reduced. In addition, the checking results may further detect component aging or distortion for warning purpose.

The present invention provides a cassette exchange system, which includes a wafer temporary storage apparatus, a first cassette base, a second cassette base and a moving apparatus. The wafer temporary storage apparatus includes a main body and a plurality of wafer carrier units. Wherein, each of the wafer carrier units includes a first end and a second end opposed to the first end, and the first end connects with the main body. The first cassette base carries a first cassette. The second cassette base carries a second cassette. In addition, the moving apparatus connects with the first cassette base and the second cassette base so as to sequentially move the first cassette base and the second cassette base to the wafer temporary storage apparatus, and simultaneously to transfer a plurality of wafers in the first cassette to the second cassette by the wafer carrier units. Or, the moving apparatus connects with the wafer temporary storage apparatus to move the wafer temporary storage apparatus to the first cassette base and the second cassette base in sequence, and to simultaneously transfer the wafers in the first cassette to the second cassette by the wafer carrier units.

According to the cassette exchange system of a preferred embodiment of the present invention, the moving apparatus includes at least one horizontally moving unit and at least one vertically moving unit.

According to the cassette exchange system of a preferred embodiment of the present invention, the first cassette base and the second cassette base are on the same or different horizontal planes.

According to the cassette exchange system of a preferred embodiment of the present invention, the system further includes at least two sensors disposed at the second end of at least one of the wafer carrier units.

The present invention also provides a cassette exchange method. The cassette exchange method first provides a cassette exchange system (step (a)), the cassette exchange system including a plurality of wafer carrier units, a first cassette with a plurality of wafers and a second cassette. Then, the wafer carrier units are moved to the first cassette (step (b)). Simultaneously, the wafers in the first cassette are unloaded by the wafer carrier units so that the wafers are on the wafer carrier units (step (c)). Next, the wafer carrier units with the wafers are moved to the second cassette (step (d)). Simultaneously, the wafers from the wafer carrier units are loaded into the second cassette by the wafer carrier units (step (e)).

According to the cassette exchange method of a preferred embodiment of the present invention, in the step (a), a determining unit is provided. The cassette exchange system further includes a first sensor and a second sensor. Between the steps (b) and (c), the method further includes the following steps: (b′) performing a checking step to the first cassette by the first sensor and the second sensor to generate a first signal and a second signal; and (b″) transmitting the first signal and the second signal to the determining unit. Wherein, when the determining unit determines that the first signal is equal to the second signal, or that the first signal and the second signal are equal to a preset signal of the determining unit, steps from the step (c) are performed; or when the determining unit determines that the first signal is not equal to the second signal, or that the first signal and the second signal are not equal to the preset signal of the determining unit, steps from the step (c) are not performed.

The cassette exchange system includes a plurality of wafer carrier units. All wafers in one cassette can be simultaneously transferred to another cassette. Accordingly, the wafer transfer efficiency is improved and the process time is reduced.

In addition, in one embodiment the first sensor and the second sensor are disposed on at least one of the wafer carrier units of the cassette exchange system. The checking results generated by the sensors determine whether to load or unload the wafers in the cassette before loading or unloading the wafers. Accordingly, the chance of scratching the wafer surface or backside during the wafer transfer is reduced. In addition, the checking results may further detect component aging or distortion for warning purpose.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a schematic drawing showing a wafer transfer system according to a preferred embodiment of the present invention.

FIG. 2 is a flowchart showing a wafer transfer method of a preferred embodiment of the present invention.

FIG. 3 is a schematic drawing showing the wafer transfer process in FIG. 2.

FIGS. 4A and 4B are schematic drawings showing another wafer transfer process in FIG. 2.

FIGS. 5A and 5B are schematic drawings showing the other wafer transfer process in FIG. 2.

FIG. 6 is a schematic drawing showing a cassette exchange system according to a preferred embodiment of the present invention.

FIG. 7 is a schematic drawing showing another cassette exchange system according to a preferred embodiment of the present invention.

FIG. 8 is a schematic drawing showing a cassette exchange system according to a preferred embodiment of the present invention.

FIG. 9 is a schematic drawing showing a cassette exchange system according to a preferred embodiment of the present invention.

FIGS. 10A-10E are schematic drawings showing a flowchart of a wafer transfer method according to a preferred embodiment of the present invention.

### DESCRIPTION OF SOME EMBODIMENTS

### First Embodiment

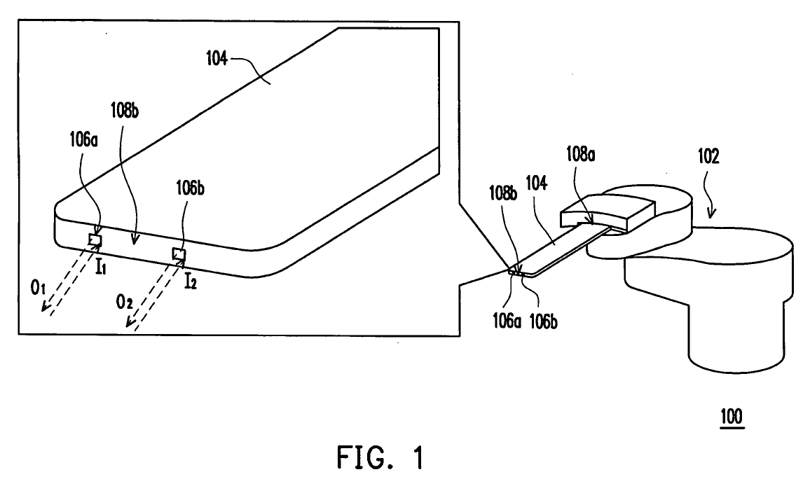

FIG. 1 is a schematic drawing showing a wafer transfer system according to a preferred embodiment of the present invention.

Referring to FIG. 1, the wafer transfer system 100 of the present invention includes the movable main body 102, at least one wafer carrier unit 104 and at least two sensors 106a and 106b.

Wherein, the movable body 102 can be, for example, a robot blade which can move up or down, rotate and retract. In addition, the wafer carrier unit 104 includes a first end 108a, and a second end 108b opposed to the first end 108a. The first end 108a connects with the movable main body 102. In addition, the wafer carrier unit 104 can be, for example, a plate carrier unit. Of course, the shape of the wafer carrier unit 104 is not specified. It can be designed based on the different cassettes.

In addition, the sensors 106a and 106b are disposed at the second end 108b of the wafer carrier unit 104. In other words, the sensors 106a and 106b are disposed at the front end of the wafer carrier unit 104. In detail, the sensors 106a and 106b transmit the output signals O1 and O2 to the object which is going to be detected. The sensors 106a and 106b then receive the input signals I1 and I2 from the object. Accordingly, the sensing purpose is achieved. In addition, the sensing method can be, for example, a thermal sensing method, a pressure sensing method or an ultrasonic sensing method. It means that by the reflectivity of the object, the wavelength and other physical properties, the sensing purpose can be achieved. Accordingly, the signal related to the height of the sensor or the signal showing whether a barrier is in front of the front end of the wafer carrier unit is obtained. In a preferred embodiment, the sensors 106a and 106b can be, for example, optical sensors, such as fiber sensors, infrared (IR) sensors or ultraviolet (UV) sensors. In an embodiment, the sensors 106a and 106b can be, for example, wired sensors. For example, the wire sensors can be disposed in the wafer carrier unit 104 or other components. The disposition of the wired sensors should not affect the motions of the mechanism. In another embodiment, the sensors 106a and 106b can be, for example, wireless sensors. Through the disposition of signal receivers, sensing signals from the sensors 106a and 106b are obtained.

Following are descriptions of a wafer transfer method. Note that the wafer transfer method below is an embodiment of applying the wafer transfer system described above. The present invention, however, is not limited thereto.

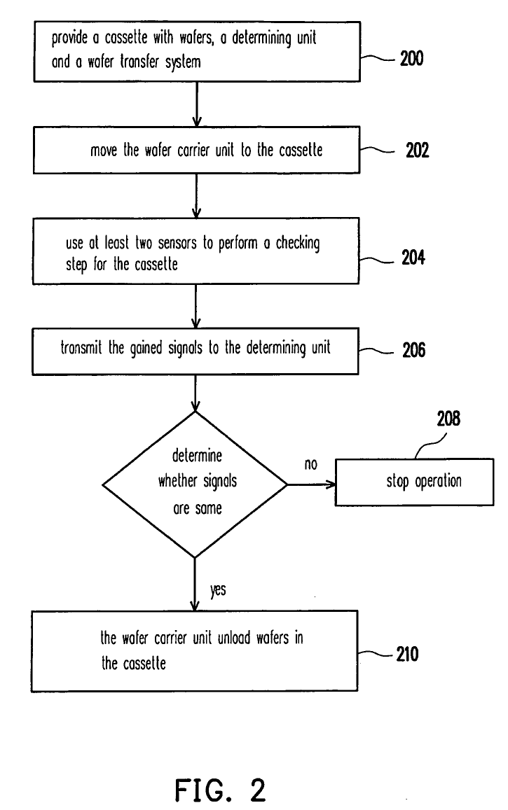

FIG. 2 is a flowchart showing a wafer transfer method of a preferred embodiment of the present invention. The wafer transfer method of the present invention includes the following steps.

In the step 200, the cassette with wafers, the determining unit and the wafer transfer system are provided. Wherein, the wafer transfer system includes the wafer carrier unit, and at least two sensors. In a preferred embodiment, the wafer transfer system is the transfer system shown in FIG. 1. Additionally, the cassette can be, for example, a cassette which can accommodate 25 or more wafers. Its material can be plastic, metal or other materials. Moreover, the determining unit can be, for example, a comparator or a calculator.

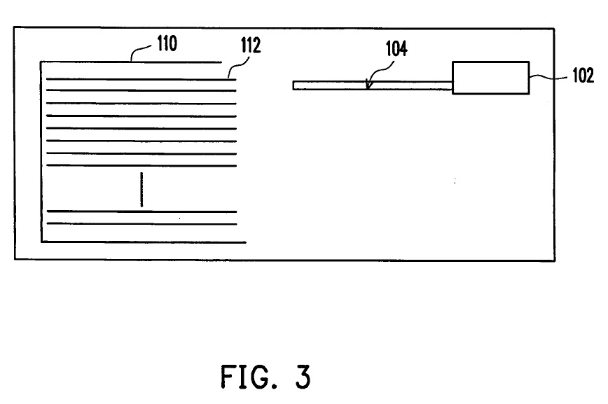

Then, the wafer carrier unit is moved to the cassette (step 202). At this moment, the wafer carrier unit 104, under the normal situation, is in the gap between two neighboring wafers 112 in the cassette 110 as shown in FIG. 3. If the wafer carrier unit cannot be moved to the proper position due to the component aging or distortion of the wafer transfer system, but still loads the wafers, the wafer surface or backside is subject to scratches, or the wafer may be broken. Accordingly, it is desired to perform the checking steps for the cassette before the wafers are unloaded. Then, the wafers are unloaded. Following are detail descriptions.

After the wafer carrier unit is moved to the cassette, at least two sensors are used to perform the checking steps for the cassette (step 204) to obtain at least two signals. The obtained signals then are transmitted to the determining unit (step 206) to determine whether to continue unloading the wafers. In detail, when the determining unit determines that these two signals are same, or that these two signals are equal to the preset signal in the determining unit, the steps (i.e., the steps from step 210) of unloading the wafers are performed. If the determining unit determines these two signals are different, or these two signals are different from the preset signal in the determining unit, the operation of the system stops (step 208).

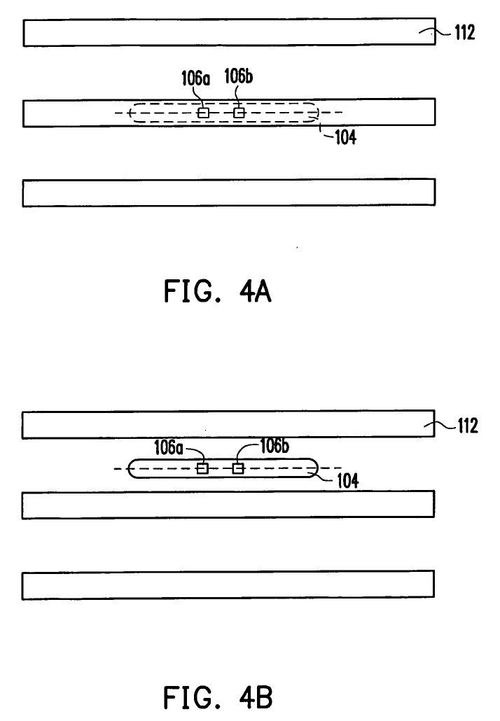

For example, the wafer carrier unit 104 is not in the gap between two neighboring wafers 112 as shown in FIG. 4A. Instead, the wafer carrier unit 104 is located at the side face of the wafers 112. At this moment, the signals received by the sensors 106a and 106b are different from the signals which indicate that the wafer carrier unit 104 is at the proper position as shown in FIG. 4B. Wherein, the signals which indicate that the wafer carrier unit 104 is at the proper position are the preset signals stored in the determining unit, or the sensing signals recorded in the previous sensing step. The obtained signals show that a barrier is in front of the front end of the wafer carrier unit 104.

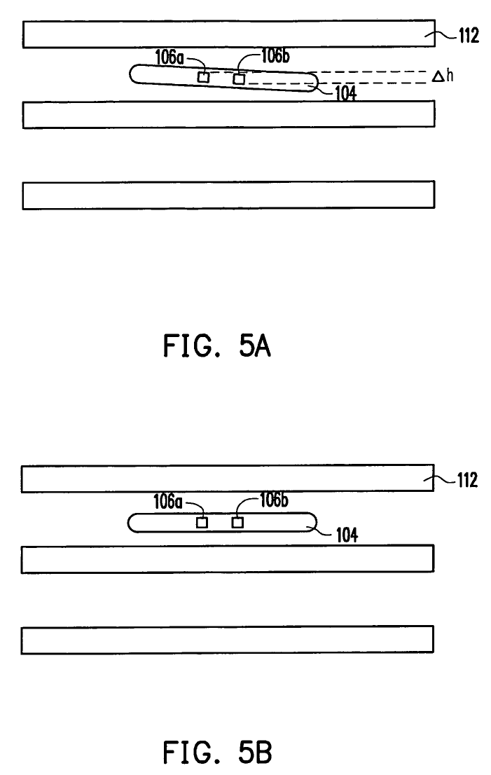

Additionally, the sensors 106a and 106b may also detect the aging, distortion or tilt of the wafer carrier unit or the wafer transfer system. For example, if the wafer carrier unit 104 tilts on its own or results from the tilt of the wafer transfer system as shown in FIG. 5A, the sensors 106a and 106b are not on the same horizontal plane. The sensing signals obtained from the sensors 106a and 106b thus are different, or even different from the signals which indicate the wafer carrier unit 104 is at the proper position as shown in FIG. 5B. Wherein, the signals which indicate that the wafer carrier unit 104 is at the proper position are the preset signals stored in the determining unit, or the sensing signals recorded in the previous sensing step. The obtained signals are signals showing the height of the sensors. It means that due to the tilt of the wafer carrier unit 104, a height differential Δh occurs between the sensors 106a and 106b. The height differential Δh is sensed by the sensors 106a and 106b, and the sensing result is transmitted to the determining unit. In a preferred embodiment, when the determining unit determines a tilt of the wafer carrier unit 104, a compensation mechanism is triggered to correct the tilt. In some embodiments, after receiving the sensing result, an operator may handle the issue of the tilt of the wafer carrier unit 104 immediately.

According to the sensing results from the sensors 106a and 106b, the operator can understand if the wafer carrier unit is at the proper position. The issue of scratching the wafer surface or backside by the wafer carrier unit is avoided during the wafer transfer. Moreover, based on the sensing results, the operator can check the related equipment immediately to find out the reason of causing the signal difference so that proper processes can be performed right away.

After performing the determining step, if the determining unit determines that the wafers can be unloaded, the wafer carrier unit then unloads the wafers in the cassette (step 210). Wherein, according to the unload method for the wafers, the wafer carrier unit is moved into the cassette. The wafer carrier unit then moves upward to hold or vacuum chuck the wafer backside. The wafer carrier unit is then moved out, and the wafer is moved out of the cassette as well. Since the checking and determining steps described above have been performed, the wafer can be unloaded without scratches during the process of unloading the wafer from the cassette.

Accordingly, the wafer transfer system described above includes at least two sensors. Before performing the wafer transfer, the checking results from these two sensors are used to determine whether to unload the wafer from the cassette. During the wafer transfer, the issue of scratching the wafer surface or backside by the wafer carrier unit is effectively avoided. Moreover, the checking results may also detect the component aging or distortion in the wafer transfer system for the warning purpose.

Note that the transfer of a wafer in the embodiment described above is only exemplified by illustration. The present invention, however, is not limited thereto. It means that if there are two or more wafers in the cassette, the unloading of other wafers can go through the same checking and determining steps by the sensors before the unload process. Additionally, the number of the sensors disposed at the front end of the wafer carrier unit according to the present invention is not limited to two. The number of the sensors varies with different requirements.

### Second Embodiment

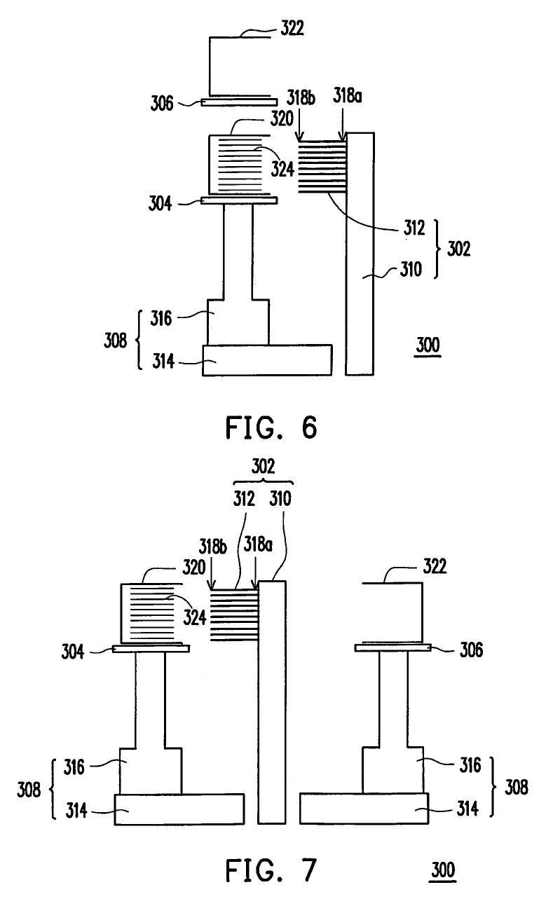

FIG. 6 is a schematic drawing showing a cassette exchange system according to a preferred embodiment of the present invention.

Referring to FIG. 6, the cassette exchange system 300 of the present invention includes at least the wafer temporary storage apparatus 302, the cassette bases 304 and 306 and the moving apparatus 308. Wherein, the wafer temporary storage apparatus 302 includes the main body 310 and a plurality of wafer carrier units 312. In addition, the moving apparatus 308 includes at least one horizontally moving unit 314 and at least one vertically moving unit 316.

Wherein, each of the wafer carrier units 312 includes the first end 318a and the second end 318b opposed to the first end 308a. The first end 308a connects with the movable main body 310. In addition, the wafer carrier unit 312 can be, for example, a plate carrier unit. Of course, the shape of the wafer carrier unit 312 is not specified. It can be designed based on the different cassettes.

Additionally, the cassette bases 304 and 306 accommodate the cassettes 320 and 322, respectively. The cassettes 320 and 322 are cassettes which accommodate 25 or more wafers, for example. Their material can be, for example, plastic or metal.

In addition, the moving apparatus 308 connects the cassette base 304 with the cassette base 306, and sequentially moves the cassette bases 304 and 306 to the wafer temporary storage apparatus 302. Accordingly, plural of the wafers 324 in the cassette 320 are simultaneously loaded to the cassette 322 by the wafer carrier units 312. Wherein, the horizontally moving unit 314 of the moving apparatus 308 can be, for example, a sliding apparatus, and the vertically moving unit 316 of the moving apparatus 308 can be, for example, a lift apparatus.

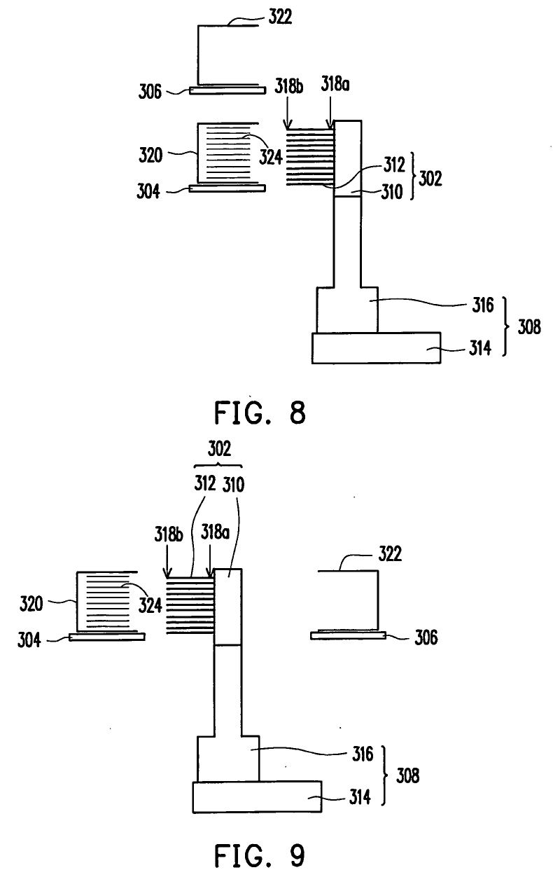

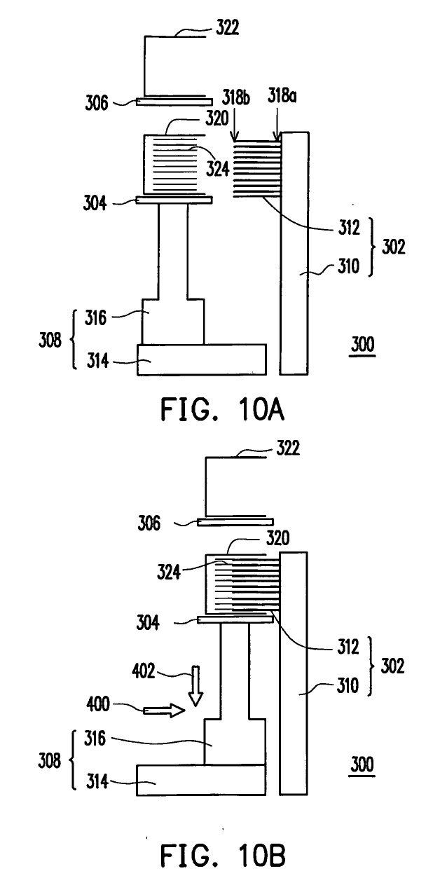

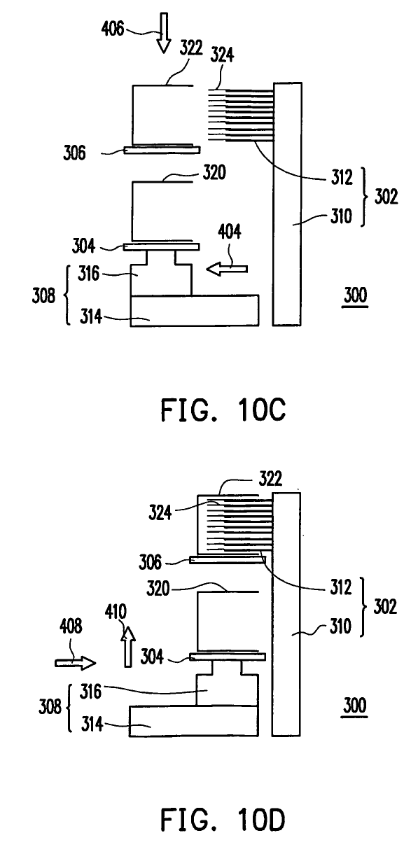

In the embodiment described above, the cassettes 304 and 306 of the cassette exchange system are on different horizontal planes. The present invention, however, is not limited thereto. In another embodiment, the cassettes 304 and 306 of the cassette exchange system are on the same horizontal plane as shown in FIG. 7. In an embodiment, the moving apparatus 308 connects with the wafer temporary storage apparatus 302, and the cassettes 304 and 306 are on the same or different horizontal planes as shown in FIGS. 8 and 9.

In the cassette exchange system shown in FIGS. 6-9 or other exemplary embodiments of the cassette exchange system according to the present invention, at least two sensors are disposed at the second end 318b of at least one wafer carrier unit 312. The sensors can be same as the sensors 106a and 106b shown in FIG. 1. The descriptions of the sensors 106a and 106b are shown in the first embodiment. Detailed descriptions are not repeated.

Following are descriptions of a cassette exchange method based on the cassette exchange system described above. Note that the cassette exchange method below is an application of the cassette exchange system described above. The present invention, however, is not limited thereto.

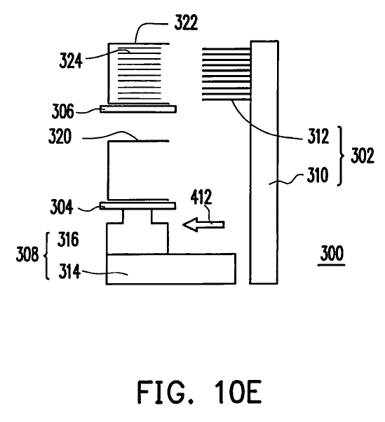

FIGS. 10A-10D are figures showing a flowchart of a wafer transfer method according to a preferred embodiment of the present invention.

Referring to FIG. 10A, a cassette exchange system is first provided in the cassette exchange method of the present invention. The cassette exchange system includes a plurality of wafer carrier units 312, the cassette 320 accommodating a plurality of wafers 324 and the cassette 322. In a preferred embodiment, the cassette exchange system can be, for example, the cassette exchange system 300 shown in FIG. 6. The descriptions are shown in the previous embodiment. Detailed descriptions are not repeated.

An operator then puts the cassettes 320 and 322 on the cassette bases 304 and 306, respectively. The cassette 320 is then moved to the wafer carrier units 312.

Referring to FIG. 10B, the wafer carrier units 312 simultaneously unload the wafers 324 in the cassette 320, and rest the wafers 324 on the wafer carrier units 312. Wherein, according to the unload method for the wafers 324, the horizontally moving unit 314 horizontally moves the cassettes 320 and 322 to the wafer carrier units 312 (shown by arrow 400), for example. Each of the wafer carrier units 312 inserts into the gap of two neighboring wafers 324. The vertically moving unit 316 descends the cassettes 320 and 322 to a proper height so that the wafers 324 rest on the wafer carrier units 312 (shown by arrow 402). The wafer carrier units 312 then vacuum chuck the wafers 324.

Note that if at least two sensors, such as the sensors 106a and 106b shown in FIG. 1A, are disposed at the front end of at least one wafer carrier unit 312 of the cassette exchange system 300, checking steps can be performed to the cassette 320 to determine whether the wafer carrier unit 312 is located at a proper position before the step in FIG. 10B is performed. Then, the unload step for the wafers in FIG. 10B is performed. Damage to the wafers can be reduced, and the condition of the whole system can be monitored. The checking and determining steps by the sensors 106a and 106b have been disclosed in the first embodiment. Detailed descriptions are not repeated.

Referring to FIG. 10C, the cassette 322 is moved to the wafer carrier units 312 carrying the wafers 324. According to the method of moving the cassette 322 to the wafer carrier units 312, the horizontally moving unit 314 horizontally moves out the cassettes 320 and 322 (shown by arrow 404), for example. It means that the wafer carrier units 312 are separated from the cassette 320 by a distance. Then, the vertically moving unit 316 moves the cassette 322 downwards to a proper height, i.e., the cassette 322 is moved to the height where the cassette 320 originally locates (shown by arrow 406).

Referring to FIG. 10D, the wafer carrier units 312 simultaneously load the wafers thereon in the cassette 322. According to the method of loading the wafers 324 in the cassette 322, the horizontally moving unit 314 horizontally moves the cassettes 320 and 322 (shown by arrow 408), and the vacuum system is turned off, for example. Each of the wafer carrier units 312 moves into the gap between two neighboring wafers 324. The vertically moving unit 316 then moves the cassettes 320 and 322 upwards to a proper height so that the wafers 324 rest in the cassette 322 (shown by arrow 410).

Note that if at least two sensors, such as the sensors 106a and 106b shown in FIG. 1A, are disposed at the front end of at least one wafer carrier unit 312 of the cassette exchange system 300, checking steps can be performed to the cassette 320 to determine whether the wafer carrier unit 312 is located at a proper position before the step in FIG. 10D is performed. Then, the load step for the wafers in FIG. 10D is performed. Damage to the wafers can be reduced, and the condition of the whole system can be monitored. The checking and determining steps by the sensors 106a and 106b have been disclosed in the first embodiment. Detailed descriptions are not repeated.

Referring to FIG. 10E, the wafer carrier units 312 are moved out from the cassette 322. According to the method of moving out the wafer carrier units 312, the horizontally moving unit 314 horizontally moves the cassettes 320 and 322 (shown by arrow 412). It means that the wafer carrier units 312 are separated from the cassette 322 by a distance.

Note that the cassette exchange system includes a plurality of wafer carrier units. All wafers in a cassette can be simultaneously transferred to another cassette by the wafer carrier units. Accordingly, the wafer transfer efficiency is improved and the process time is reduced.

In the embodiment described above, the cassette exchange system shown in FIG. 6 is used to interpret the cassette exchange method. The present invention, however, is not limited thereto. It means that the cassette exchange method can also be applied to the cassette exchange systems in FIGS. 7-9 or other cassette exchange systems. The cassette exchange method is performed by the horizontal moving and the vertical moving of the moving apparatus. In addition, the cassette exchange method of the present invention is not limited to the wafer transfer from the cassette 320 to the cassette 322. It may include the wafer transfer from the cassette 322 to the cassette 320 as well.

Accordingly, since the cassette exchange system includes a plurality of wafer carrier units, all wafers in a cassette can be simultaneously transferred to another cassette by the wafer carrier units. Accordingly, the wafer transfer efficiency is improved and the process time is reduced.

In addition, if at least two sensors are disposed on at least one wafer carrier unit of the cassette exchange system, the checking results generated by the sensors determine whether to load or unload the wafers in the cassette before loading or unloading the wafers. Accordingly, the chance of scratching the wafer surface or backside during the wafer transfer is reduced. In addition, the checking results may further detect component aging or distortion for warning purpose.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A cassette exchange system, comprising:
a wafer temporary storage apparatus, the wafer temporary storage apparatus comprising:
a main body; and
a plurality of wafer carrier units, wherein each of the wafer carrier units comprises a first end and a second end opposed to the first end, and the first end connects with the main body;
a first cassette base, carrying a first cassette;
a second cassette base, carrying a second cassette; and
a moving apparatus, connecting with the first cassette base and the second cassette base so as to sequentially move the first cassette base and the second cassette base to the wafer temporary storage apparatus, and simultaneously to transfer a plurality of wafers in the first cassette to the second cassette by the wafer carrier units; or the moving apparatus connecting with the wafer temporary storage apparatus to move the wafer temporary storage apparatus to the first cassette base and the second cassette base in sequence, and simultaneously to transfer the wafers in the first cassette to the second cassette by the wafer carrier units.

2. The cassette exchange system of claim 1, wherein the moving apparatus comprises at least one horizontally moving unit and at least one vertically moving unit.

3. The cassette exchange system of claim 1, wherein the first cassette base and the second cassette base are on the same or different horizontal planes.

4. The cassette exchange system of claim 1, further comprising at least two sensors, which are disposed at the second end of at least one of the unit carrier units.

5. The cassette exchange system of claim 4, wherein the sensors comprise optical sensors, wireless sensors, or wired sensors.
